(19) United States
(12) Patent Application Publication
(10) Pub. No.: US 2026/0222660 A1
(43) Pub. Date: Jul. 30, 2026

(54) PANEL ASSEMBLY FOR A VEHICLE AND MANUFACTURING METHOD THEREOF

(71) Applicant: TURKIYE SISE VE CAM FABRIKALARI ANONIM SIRKETI, Istanbul (TR)

(72) Inventors: Cagatay SUNER, Istanbul (TR); Evrim GUNDUZ TULUMEN, Istanbul (TR); Burcu OGUT, Istanbul (TR)

(73) Assignee: TURKIYE SISE VE CAM FABRIKALARI ANONIM SIRKETI, Istanbul (TR)

(21) Appl. No.: 19/152,031

(22) PCT Filed: Dec. 29, 2023
(86) PCT No.: PCT/TR2023/051829

§ 371 Date: Jul. 30, 2025

(30) Foreign Application Priority Data
Jan. 31, 2023 (TR) 2023/001134

(51) Int. Cl. H04N 23/51; B32B 3/26; B32B 17/10

(52) U.S. Cl. CPC H04N 23/51; B32B 3/266; B32B 17/10036; B32B 17/10165; B32B 17/10761

(57) ABSTRACT

A panel assembly for a vehicle, includes: a composite laminated panel with an inner panel; an outer panel adjacent to the inner panel; and a thermoplastic intermediate panel bonding the inner and outer panels together. A through-hole extends between an inner surface of the inner panel and an outer surface of the outer panel on the laminated panel, and a gasket provides a seal between the hole and a sensor positioned within the hole, and surrounds the sensor in a manner that securing it to the laminated panel.

### CROSS REFERENCE TO THE RELATED APPLICATIONS

This application is the national phase entry of International Application No. PCT/TR2023/051829, filed on Dec. 29, 2023, which is based upon and claims priority to Turkish Patent Application No. 2023/001134, filed on Jan. 31, 2023, the entire contents of which are incorporated herein by reference.

### TECHNICAL FIELD

The present invention relates to a laminated panel assembly with a thermoplastic intermediate layer, particularly a vehicle glass, and its manufacturing method.

### BACKGROUND

A vehicle glass is a laminated panel structure with an outer panel, an inner panel adjacent to each other, and a thermoplastic intermediate layer including PVB, bonding the inner and outer panels. In the windshield, the composite panel has a trapezoidal in shape.

Advanced camera systems (ADAS) and forward-facing sensors are generally mounted near the central area close to the upper edge, facing the inner surface of the inner panel, usually referred to as the sensor window. The sensor window is the area through which the electromagnetic wave passes from inside the windshield and is detected by the sensor. Measures are taken to prevent the laminated panel from distorting the sensor input signal. A known measure is to create a cut-out in the inner panel at the sensor window and to reduce the thickness of the panel section for the sensor signal.

WO2021041839 describes a glass for use in automotive vehicles containing a camera responsive to infrared electromagnetic waves with a wavelength greater than 20 μm. The glass has an outer surface and an inner surface, the latter defined by a first panel, which is arranged opposite to the outer surface on the first panel. The first panel has a peripheral edge defining the outer circumference of the first panel. The first panel also includes a portal within the peripheral edge of the first panel, between the inner and outer surfaces of the first panel; and a second panel defining an outer surface and an inner surface, with the inner surface of the second panel placed opposite to the outer surface of the second panel. The second panel is oriented relative to the first panel so that the inner surface of the second panel faces the inner surface of the first transparent layer. At least a part of the second panel covers the portal of the first panel, and the material of the second panel is selected from a group containing zinc sulfide and polycarbonate.

### SUMMARY

The object of the invention is to enhance sensor sensitivity in a laminated panel with a thermoplastic intermediate layer, particularly in vehicle windshields.

In order to achieve the above objective, the invention relates to a panel assembly for a vehicle including a composite laminated panel that includes an inner panel; an outer panel adjacent to the inner panel; and a thermoplastic intermediate panel bonding the inner and outer panels together. The panel assembly includes a through-hole is extending between an inner surface of the inner panel and an outer surface of the outer panel on the laminated panel, and a gasket that seals the hole, and a sensor is positioned within the hole by surrounding the sensor and securing it to the laminate. The gasket prevents wind, water, or other external elements from entering through the hole by surrounding the sensor. Since the sensor has access to the outer environment through the hole in the laminated panel, any potential for the laminated panel to create distortion lead reduction/decrease on signals to the sensor, such as radiation or electromagnetic signals, is eliminated. The sensor may have inherent elements that do not limit its access to internal and external signals, such as a lens or protective glass.

Preferably, a casing is directly supported by the gasket at the laminated panel and at least partially surrounds the sensor. The casing is supported by the gasket and the need for an additional support structure in the laminated panel that would narrow the field of view to carry the sensor is eliminated. In possible configurations, the casing can be adjusted within the hole to align with the inner and outer surfaces or extend partially outwards from the inner and/or outer surfaces. It could be a tube-like structure, match the shape of the hole, be in different cross-sections like a ring, or have a tray structure with raised edges.

Preferably, the gasket is made of a flexible material. A gasket made of flexible material reduces vibrations along the road transmitted to the sensor, enhancing the precision of sensor signal readings.

Preferably, the front end of the casing is aligned with the outer surface of the outer panel. In this case, the casing does not protrude outwards after the laminated panel is mounted on the vehicle, thus not adversely affecting the aerodynamic properties of the vehicle.

Preferably, the casing is made from a stiff material. This protects the sensor from internal or outer impacts within the vehicle and directly transfers the weight of the sensor to the gasket. This way, the gasket alone can carry the sensor with the casing without the need for additional support.

Preferably, the casing includes a guide structure, particularly a thread on an inner wall where an outer wall of the sensor directly engages in a leak-proof manner. This allows the sensor to be easily mounted and removed in the laminated panel where the casing is located. The thread allows for precise adjustment of the sensor's linear distance within the casing. In possible configurations, a slide or different fitting system could be used instead of a thread.

Preferably, the rear part of the casing extends inward from the inner surface across a distance equal to the thickness of the laminated panel supported by the gasket at the front part. In this case, the inward-extending part allows for the extension of the casing, enabling a long sensor, such as a camera, to be positioned in the laminated panel without leading to an axial misalignment.

Preferably, the casing and sensor are coaxially aligned. This allows for the simple forward motion installation of the sensor into the laminated panel, such as a vehicle windshield.

Preferably, the gasket includes polyurethane. Polyurethane provides resistance against external elements and sufficiently dampens vibrations in the laminated panel. Also, the application and expansion of polyurethane between the hole and the casing during installation fill the gap completely, facilitating the easy mounting of the casing in the laminated panel in the correct position. This eliminates the need for mounting elements, such as flange applications on the front and back surfaces of the laminate glass. In possible configurations, different flexible materials, such as silicone or rubber, could be used instead of polyurethane.

Preferably, the inner and outer panels are made of glass material. This meets vehicle standards and allows the use of the laminated panel as a vehicle's front or rear windshield.

Preferably, the intermediate panel is made of PVB material and directly adjacent to the inner and outer panels. This ensures a vehicle glass that complies with vehicle standards.

Preferably, the hole is provided near the central axis of the laminate glass, adjacent to an upper edge. This creates a sensor window, providing a laminated panel that complies with vehicle interior design standards and allows the sensor to have a wider viewing angle when placed near the upper edge of the vehicle.

Preferably, the sensor has a camera. The camera can capture images over the laminated panel without being affected by the laminated panel's structure, such as refractive index and coatings, which reduce optical transmittance. This achieves an ideal optical system in terms of modulation transfer function.

A preferred application includes the steps of obtaining a laminate glass by providing an inner panel, an intermediate panel, and an upper panel directly adjacent to each other in sequence; longitudinally cutting the laminate glass to provide a hole; and providing a ring-shaped gasket within the hole. The geometry of the hole in possible configurations could be a closed geometry, such as a circle, triangle, trapezoid, oval, etc., distanced from the upper edge of the laminate glass, or an open geometry towards the upper edge may be preferred.

A preferred application includes the step of mounting a casing onto an inner wall of the gasket from an outer wall. The casing can be placed by passing through the gasket, or the gasket can be applied after fixing the casing within the hole.

### BRIEF DESCRIPTION OF THE DRAWINGS

FIG. 1 is a front view of a representative laminated panel according to the subject matter invention.

FIG. 2 is a cross-sectional view along lines A-A of the vehicle glass application with a mounted camera as shown in FIG. 1,

FIG. 3 is a front view of alternative configurations including holes of different geometries of the laminated panel according to the subject matter invention.

Reference Numbers:

1 Inner panel
2 Intermediate panel
3 Outer panel
10 Laminated panel
11 Upper edge
12 Inner surface
14 Outer surface
16 Hole
20 Gasket
22 Outer wall
24 Inner wall
30 Casing
32 Outer surface
34 Inner wall
35 Front part
40 Sensor
42 Outer wall
44 Front end
M Central axis

### DETAILED DESCRIPTION OF THE EMBODIMENTS

This detailed description explains the invention and its preferred embodiments in a way that is intended to help understanding without imposing any limitations.

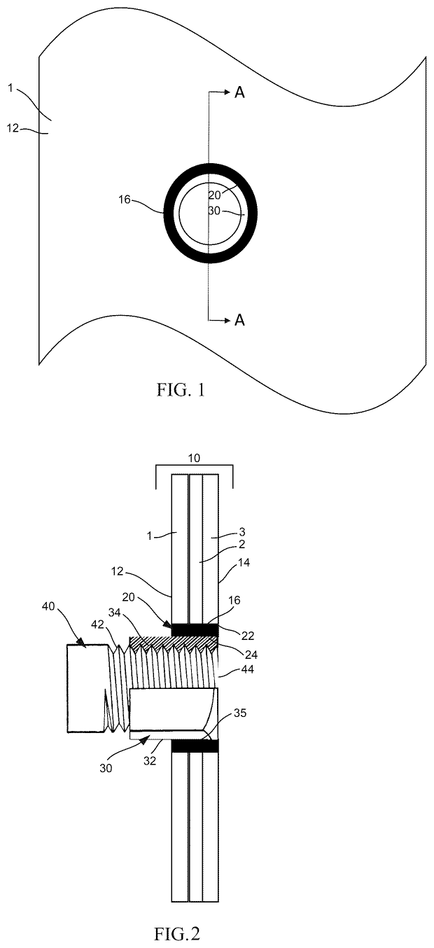

FIG. 1 shows the vehicle's windshield from a front perspective view, from inside the vehicle. The windshield includes a laminated panel (10) with an inner panel (1) made of glass, having a thickness between 0.7-2.5 mm. The inner panel (1) is trapezoidal in shape and its inner surface (12) is concavely curved. A circular through-hole (16) is provided on the laminated panel (10). A gasket (20), made of polyurethane material and ring-shaped, extends radially inwards along the circumference of the hole (16) and is mounted to the laminated panel (10). A coaxial plastic cylindrical casing (30) is inserted within the gasket (20).

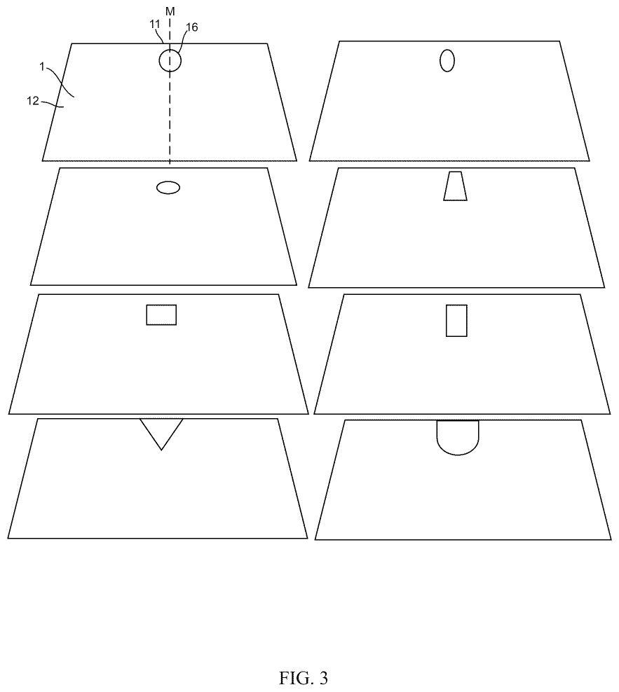

FIG. 2 shows a cross-sectional view from the top part, referred to as the sensor window, of the vehicle's windshield. The inner panel (1) and an outer panel (3) are of similar dimensions and slopes and are joined together with an intermediate panel (2) made of PVB material to form the laminated panel (10). The laminated panel (10) is bent and cooled at a temperature between 500 to 700 C to take on a curved shape. A through-hole (16) is cut over the sensor window on the laminated panel (10) using a mold blade, or alternatively with a water jet or laser beam (not shown). The hole (16) is aligned with a vertical central axis (M) passing through the center of the laminated panel (10). A coaxial casing (30) is inserted at the center of the hole (16), with a front part (35) of the casing (30) aligned with the outer surface (14) of the outer panel (3) at its outer end. In this case, polyurethane material is pressed to fill the space between the front part (35) of the casing (30) remaining inside the hole (16) and the hole (16) itself in a leak-proof manner, forming the gasket (20). The gasket (20) fits such that completely surrounds the hole (16) from a radial outer wall (22). On the other hand, the gasket (20) secures the casing (30) by pressing radially inwardly from an opposite inner wall (24) at the front part (35). Thus, the hole (16), gasket (20), and casing (30) are coaxially secured in the laminated panel (10). Due to the flexible polyurethane material of the gasket (20) and the curved structure of the laminated panel (10) (not shown in the figure), the radial difference between the inner and outer edges of the hole (16) is compensated to maintain alignment between the extension axis of the casing (30) and the co-axis of the hole (16). The inner wall (34) of the casing (30), opposite to the outer surface (32) where it sits on the gasket (20), encircles a cylindrical gap and has a throughout thread. In this manner, a sensor (40) with an appropriate thread form on its outer wall (42) is rotated along the hole axis and mounted inside the casing (30). Thanks to the thread structure, the sensor (40) can be rotated to align its flat front end (44) with the outer surface (14) of the outer panel (3) in a form-fitting manner. When the sensor (40) is mounted to the casing (30), the weight of the sensor (40) at the front part (35) creates a moment, which can generate a dynamic load along the hole (16) with vibrations in the laminated panel (10), especially when the vehicle is in motion. Since the gasket (20) is made from a flexible material, it dampens the vibrations in the laminated panel (10) where the casing (30) with the sensor (40) is directly supported, reducing the wavelength of the dynamic load. This prevents the casing (30) along with the weight of the sensor (40) from causing cracks in the inner and outer panels (1, 3) made of glass material at the inner wall of the hole (16). When the sensor (40) is fully seated in the casing (30), its front end (44) is not blocked by the laminated panel (10) in any way. Thus, the forward-facing front end (44) of the sensor (40) opens directly to the external environment. In this case, factors such as light refraction or the presence of fog, raindrops, etc., on the laminated panel (10) cannot obstruct the radiation entry at the front end (44). A lens (not shown) provided at the front end of the sensor (40) can be selected from a material different from the outer panel (3) and more suitable for the sensor (40) type in terms of electromagnetic wave transmittance and modulation transfer function values. This ensures high optical performance for the sensor (40), which is particularly beneficial for sensors used in autonomous vehicles, enabling them to provide more accurate information to the vehicle's control system and enhancing driving safety.

FIG. 3 illustrates laminated panels (10) with holes (16) of various geometries intended for use as vehicle windshields, viewed from the inner surface (12) of the inner panel (1). In the laminated panel (10), the hole (16) structure, which is close to the upper edge (11) and aligned with the central axis (M), can be circular, vertical or horizontal elliptical, vertical trapezoidal, or extend in horizontal or vertical rectangular shapes. Additionally, holes (16) of different geometries, such as a triangle with one side open to the upper edge (11) or a rounded rectangle, can be utilized. The gasket (20) is applied to the hole (16) in a leak-proof manner, completely filling the said hole (16) geometry and wrapping around the casing (30).

What is claimed is:

1. A panel assembly for a vehicle, comprising a composite laminated panel, wherein the composite laminated panel comprises:
an inner panel;
an outer panel adjacent to the inner panel; and
a thermoplastic intermediate panel bonding the inner panel and the outer panel together;
wherein a hole extends between an inner surface of the inner panel and an outer surface of the outer panel on the composite laminated panel, and
a gasket is provides a seal between the hole and a sensor positioned within the hole, and surrounds the sensor to secure the sensor to the composite laminated panel.

2. The panel assembly according to claim 1, wherein a casing is supported directly by the gasket in the composite laminated panel and at least partially surrounds the sensor.

3. The panel assembly according to claim 1, wherein the gasket is made of a flexible material.

4. The panel assembly according to claim 2, wherein the casing is aligned at a front end with the outer surface of the outer panel.

5. The panel assembly according to claim 2, wherein the casing is made from a stiff material.

6. The panel assembly according to claim 5, wherein a guide structure comprising a thread is provided within an inner wall of the casing, wherein an outer wall of the sensor directly engages with the inner wall of the casing through the thread in a leak-proof manner.

7. The panel assembly according to claim 2, wherein a rear part of the casing extends inward from the inner surface and is supported at a front part by the gasket across a distance equal to a thickness of the composite laminated panel corresponding to the hole.

8. The panel assembly according to claim 2, wherein the casing and the sensor are coaxially aligned.

9. The panel assembly according to claim 1, wherein the gasket comprises polyurethane.

10. The panel assembly according to claim 1, wherein the inner panel and the outer panel are made of glass material.

11. The panel assembly according to claim 1, wherein the thermoplastic intermediate panel is made of PVB material and directly adjacent to the inner panel and the outer panel.

12. The panel assembly according to claim 1, wherein the hole is provided near a central axis (M) of the composite laminated panel, adjacent to an upper edge.

13. The panel assembly according to claim 1, wherein the sensor comprises a camera.

14. A method for producing the panel assembly according to claim 1, comprising:
obtaining the composite laminated panel through a direct adjacent placement of the inner panel, the thermoplastic intermediate panel, and the upper panel on top of each other;
longitudinally cutting the composite laminated panel to provide the hole; and
providing the gasket within the hole, wherein the gasket is ring-shaped.

15. The method according to claim 14, further comprising:
mounting a casing onto an inner wall of the gasket from an outer wall.

16. The panel assembly according to claim 2, wherein the gasket is made of a flexible material.

17. The panel assembly according to claim 3, wherein the casing is aligned at a front end with the outer surface of the outer panel.

18. The panel assembly according to claim 3, wherein the casing is made from a stiff material.

19. The panel assembly according to claim 4, wherein the casing is made from a stiff material.

20. The panel assembly according to claim 3, wherein a rear part of the casing extends inward from the inner surface and is supported at a front part by the gasket across a distance equal to a thickness of the composite laminated panel corresponding to the hole.
